(19) United States
(12) Patent Application Publication
(10) Pub. No.: US 2014/0119510 A1
(43) Pub. Date: May 1, 2014

(54) X-RAY IMAGING SYSTEM FOR GRNERATING SPACE TRANSFER FUNCTIONS AND METHOD THEREOF

(71) Applicant: SHOW CHWAN MEMORIAL HOSPITAL, Changhua City (TW)

(72) Inventors: Min-Liang WANG, Lukang Township (TW); Pei-Yuan Lee, Changhua City (TW); Kai-Che Liu, Lukang Township (TW)

(73) Assignee: Show Chwan Memorial Hospital, Changhua City (TW)

(21) Appl. No.: 13/661,214

(22) Filed: Oct. 26, 2012

(51) Int. Cl. G01N 23/04

(52) U.S. Cl. 378/63

(57) ABSTRACT

An X-ray imaging system for generating space transfer functions has an X-ray machine, a check board and a host. The X-ray machine has an X-ray camera and an image camera to respectively take an X-ray image and a reference image for a calibration pattern on the check board. The host has a controller electrically connected to the X-ray camera and the image camera to receive the X-ray image and the reference image. The controller generates parameters and space transfer functions according to the X-ray image and the reference image. The check board of the present invention is easy to be manufactured and is convenient to use in an X-ray imaging machine

### BACKGROUND OF THE INVENTION

1. Field of the Invention

The present invention relates to an X-ray imaging system, and more particularly to a system for generating space transfer functions.

2. Description of Related Art

A conventional calibration system for an X-ray imaging equipment comprises an X-ray camera, a correction device and a computer. The correction device is mounted on the X-ray camera. The computer is electrically connected to the X-ray camera.

The correction device comprises a first substrate and a second substrate opposite to the first substrate. The first substrate and the second substrate respectively have multiple steel balls arranged uniformly. The steel balls on the second substrate are bigger than those on the first substrate.

When the X-ray camera captures an image on the correction device, the captured image shows the steel balls of the first substrate and the second substrate, wherein the steel balls in the image are not overlapped to each other. The X-ray camera then transmits the image to the computer.

The computer calibrates the X-ray camera according to the positions of the steel balls in the image. For example, the computer uses the smaller steel balls of the first substrate as signs for correcting a distortion of the image and uses the bigger steel balls of the second substrate as signs for projecting the image.

In conclusion, the steel balls act as reference points for calibrating the X-ray camera, such that the steel balls should be precisely and carefully arranged on the first substrate and the second substrate at correct positions. Therefore, to manufacture the first substrate and the second substrate is highly time-consuming and complicated. If the steel balls are not mounted correctly, the calibration result of the image will be affected.

### SUMMARY OF THE INVENTION

An objective of the present invention is to provide an X-ray imaging system for generating space transfer functions. The X-ray imaging system of the present invention has simple structure and is easy to use.

The X-ray imaging system of the present invention comprises an X-ray machine, a check board and a host.

The X-ray machine comprises a body, an X-ray generator, an X-ray camera and an image camera. The X-ray generator is mounded on the body. The X-ray camera is mounted on the body and opposite to the X-ray generator. The image camera is mounted on the body and located at a same side of the X-ray generator and opposite to the X-ray camera.

The check board is mounted between the X-ray camera and the image camera and has a substrate and multiple X-ray proof films. The substrate has a surface facing the image camera and is composed of multiple first areas and multiple second areas. The first areas and the second areas are arranged alternately. The X-ray proof films are respectively formed on the first areas to form a calibration pattern on the surface of the substrate.

The host has a controller electrically connected to the X-ray camera and the image camera.

The X-ray camera takes an X-ray image for the calibration pattern on the check board. The image camera takes a reference image for the calibration pattern on the check board. The controller receives the X-ray image and the reference image and generates parameters and space transfer functions according to the calibration patterns of the X-ray image and the reference image.

Another objective of the present invention is to provide a method for generating space transfer functions. The method of the present invention comprises the following steps:

preparing a check board, wherein the check board has a substrate with multiple first areas and second areas arranged alternately and has multiple X-ray proof films respectively formed on the first areas to form a calibration pattern;

capturing an X-ray image and a reference image for the calibration pattern of the check board by an X-ray camera and an image camera;

receiving the X-ray image and the reference image from the X-ray camera and the image camera by a controller;

finding out corner coordinates of the calibration patterns of both the X-ray image and the reference image by the controller;

generating intrinsic and extrinsic parameters for the X-ray camera and the image camera according to the corner coordinates by the controller; and

generating space transfer functions based on the X-ray image and the reference image by the controller.

In conclusion, both the X-ray camera and the image camera take images according to the same calibration pattern on the check board. The controller of the present invention can calibrate the X-ray camera and the image camera according to the same calibration pattern instead of the steel balls on two different substrates of the conventional correction device.

The check board of the present invention has a simple structure including a single substrate and X-ray proof films, instead of having multiple substrates with steel balls like the conventional correction device. Therefore, to manufacture the check board of the present invention is easier. The calibration result will be improved.

### BRIEF DESCRIPTION OF THE DRAWINGS

FIG. 1 is an operating reference diagram of the X-ray imaging system of the invention;

FIG. 2 is a perspective view of the check board of the invention; and

FIG. 3 is a flow chart of the method of the present invention.

### DETAILED DESCRIPTION OF THE PREFERRED EMBODIMENT

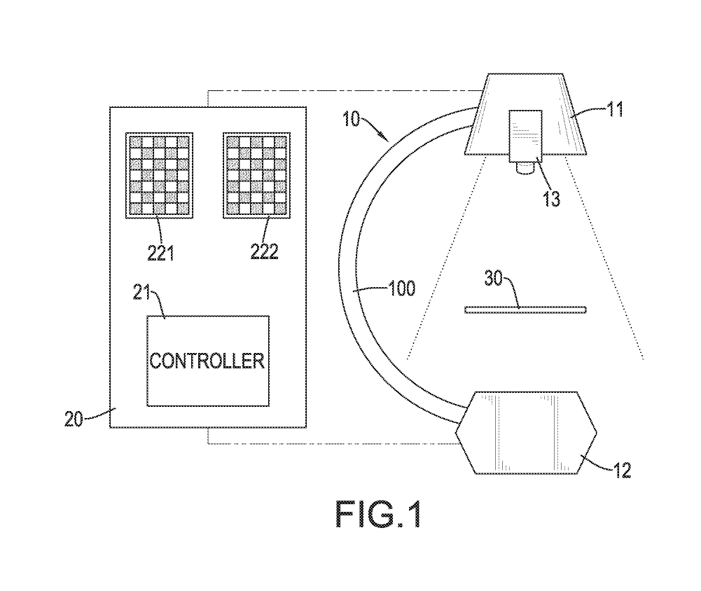

With reference to FIG. 1, a system of the present invention comprises an X-ray machine 10, a host 20 and a check board 30.

The X-ray machine 10 comprises a body 100, an X-ray generator 11, an X-ray camera 12 and an image camera 13.

The X-ray generator 11 and the X-ray camera 12 are mounted on the body 100 and opposite to each other. In this embodiment, the X-ray generator 11 is mounted above the X-ray camera 12. The image camera 13 is mounted on the body 100 and is located at a same side of the X-ray generator 11 and opposite to the X-ray camera 12. In this embodiment, the image camera 13 is a traditional pinhole camera.

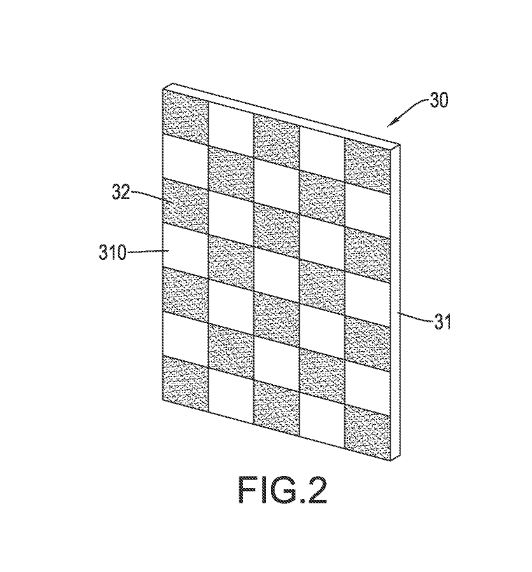

The check board 30 is movably mounted between the X-ray camera 12 and the image camera 13. With reference to FIG. 2, the check board 30 has a substrate 31 and multiple X-ray proof films 32. The substrate 31 has a surface composed of multiple first areas and multiple second areas 310. The first areas and the second areas 310 are square-shaped and are arranged alternately. The X-ray proof films 32 are respectively formed on the first areas to form a calibration pattern on the surface of the substrate 31. The X-ray proof films 32 can be metal films, such as copper films.

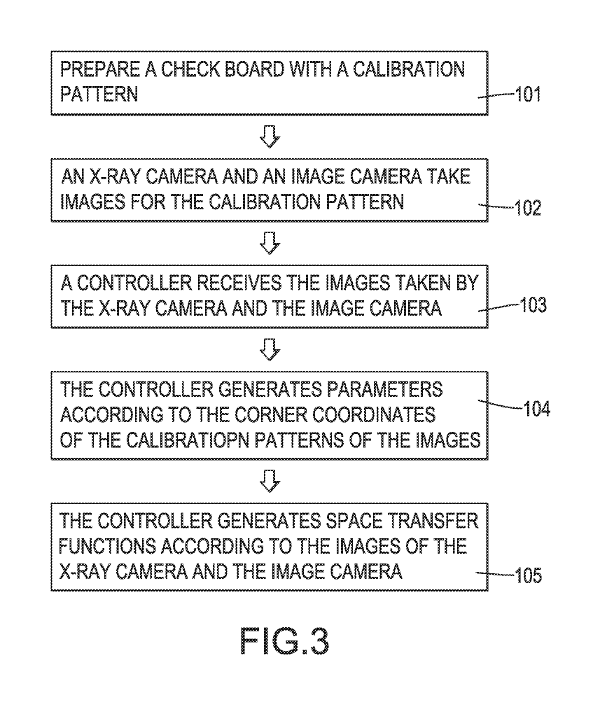

In this embodiment, the check board 30 is a substrate 31 with a copper layer. The copper layer undergoes a photolithography process and an etching process to form the X-ray proof films 32. With reference to FIG. 3, a first step of the method of the present invention is to provide the check board 30 with the calibration pattern (101).

A next step is to capture images for the calibration pattern by the X-ray camera 12 and the image camera 13 (102).

When the X-ray generator 11 irradiates X-ray toward the X-ray camera 12 through the check board 30, the X-ray camera 12 takes an X-ray image on the check board 30. Because the check board 30 has multiple X-ray proof films 32, a part of the X-ray is blocked by the X-ray proof films 32. Hence, the X-ray image captured by the X-ray camera 12 displays the calibration pattern of the check board 30. The image camera 13 faces the calibration pattern of the check board 30 to directly take a reference image for comparing with the calibration pattern.

The host 20 has a controller 21, a first monitor 221 and a second monitor 222. The controller 21 receives the X-ray image and the reference image from the X-ray camera 12 and the image camera 13 (103). The first monitor 221 displays the X-ray image and the second camera 222 displays the reference image. Hence, a user can review the images on the monitors 221, 222.

After the controller 21 receives the X-ray image and the reference image, the controller 21 calibrates the X-ray camera 12 and the image camera 13 according to the calibration patterns of the X-ray image and the reference image.

When the controller 21 calibrates the X-ray camera 12 and the image camera 13, the controller 21 firstly finds out corner coordinates of both the X-ray image and the reference image, wherein the corner coordinates indicate the intersection positions of the X-ray proof films 32 and the second areas 310 of the calibration pattern of the check board 30.

When the controller 21 obtains the corner coordinates, the controller 21 then generates parameters according to the corner coordinates (104). The parameters include intrinsic parameters and extrinsic parameters of the X-ray camera 12 and the image camera 13. For example, the intrinsic parameters include some parameters of the camera, such as lens focus, image center, aspect ratio, lens distortion, and etc. The extrinsic parameter indicates a position transfer relationship between a coordinate (x,y,z) of the image camera 13 in a 3-dimentional space and a coordinate (x1,y1,z1) of the check board 30. The extrinsic parameter can be composed of a 3×3 rotation matrix and a 3×1 translation matrix.

Also, the controller 21 generates space transfer functions based on the X-ray image and the reference image (105). The space transfer function indicates a transfer relationship between the image camera 13 and the X-ray camera 12.

The space transfer function can be composed of a 3×3 rotation matrix and a 3×1 translation matrix.

What is claimed is:

1. An X-ray imaging system for generating space transfer functions comprising:
an X-ray machine comprising:
a body;
an X-ray generator mounded on the body;
an X-ray camera mounted on the body and opposite to the X-ray generator; and
an image camera mounted on the body and located at a same side of the X-ray generator and opposite to the X-ray camera;
a check board mounted between the X-ray camera and the image camera and having:
a substrate having a surface facing the image camera and composed of multiple first areas and multiple second areas, wherein the first areas and the second areas are arranged alternately; and
multiple X-ray proof films respectively formed on the first areas to form a calibration pattern on the surface of the substrate; and
a host having a controller electrically connected to the X-ray camera and the image camera; wherein
the X-ray camera takes an X-ray image for the calibration pattern on the check board; the image camera takes a reference image for the calibration pattern on the check board; the controller receives the X-ray image and the reference image and generates parameters and space transfer functions according to the calibration patterns of the X-ray image and the reference image.

2. The X-ray imaging system as claimed in claim 1, wherein the first areas and the second areas are square-shaped.

3. The X-ray imaging system as claimed in claim 1, wherein the X-ray proof films are copper films.

4. The X-ray imaging system as claimed in claim 2, wherein the X-ray proof films are copper films.

5. The X-ray imaging system as claimed in claim 1, wherein the host has:
a first monitor electrically connected to the controller and displaying the X-ray image; and
a second monitor electrically connected to the controller and displaying the reference image.

6. The X-ray imaging system as claimed in claim 2, wherein the host has:
a first monitor electrically connected to the controller and displaying the X-ray image; and
a second monitor electrically connected to the controller and displaying the reference image.

7. The X-ray imaging system as claimed in claim 3, wherein the host has:
a first monitor electrically connected to the controller and displaying the X-ray image; and
a second monitor electrically connected to the controller and displaying the reference image.

8. The X-ray imaging system as claimed in claim 4, wherein the host has:
a first monitor electrically connected to the controller and displaying the X-ray image; and
a second monitor electrically connected to the controller and displaying the reference image.

9. A method for generating space transfer functions comprising:
preparing a check board, wherein the check board has a substrate with multiple first areas and second areas arranged alternately and has multiple X-ray proof films respectively formed on the first areas to form a calibration pattern;
capturing an X-ray image and a reference image for the calibration pattern of the check board by an X-ray camera and an image camera;
receiving the X-ray image and the reference image from the X-ray camera and the image camera by a controller;
finding out corner coordinates of the calibration patterns of both the X-ray image and the reference image by the controller;
generating intrinsic and extrinsic parameters for the X-ray camera and the image camera according to the corner coordinates by the controller; and
generating space transfer functions based on the X-ray image and the reference image by the controller.

10. The method as claimed in claim 9, wherein the check board is manufactured by a photolithography process and an etching process to form the calibration pattern.
